(19) United States
(12) Patent Application Publication
(10) Pub. No.: US 2007/0154508 A1
(43) Pub. Date: Jul. 5, 2007

(54) Antimicrobial agent to inhibit the growth of microorganisms on outerwear used in the medical profession

(76) Inventors: David L. Patton, Webster, NY (US); Syamal K. Ghosh, Rochester, NY (US); Joseph A. Manico, Rochester, NY (US); John R. Fredlund, Rochester, NY (US); Brian P. Aylward, Rochester, NY (US); Mark S. Fornalik, Rochester, NY (US); John E. Frenett, Spencerport, NY (US); Lori L. Rayburn-Zammiello, Rochester, NY (US)

Correspondence Address: Pamela R. Crocker;Patent Legal Staff, Eastman Kodak Company, 343 State Street, Rochester, NY, 14650-2201, US

(21) Appl. No.: 11/323,506

(22) Filed: Dec. 30, 2005

(51) Int. Cl. A01N 59/16; A01N 25/00

(52) U.S. Cl. 424/405; 424/618; 442/123; 977/902

(57) ABSTRACT

The present disclosure relates to an article having a fiber including an antimicrobial agent to inhibit growth of microorganisms. The article inhibits the growths of microorganisms in biological, physiological fluids, and non-biological solutions. The article includes a fibrous structure and silver halide particles applied to the fibers to inhibit the growth of the microorganism.

### CROSS REFERENCE TO RELATED APPLICATIONS

This application is related to the following co-pending and commonly-assigned patent applications, which are incorporated herein by reference in their respective entirety:

U.S. Ser. No. ______ filed concurrently herewith by David L. Patton, Syamal K. Ghosh, Joseph A. Manico, John R. Fredlund, Lori L. Raybum-Zammiello, Brian P. Aylward, Mark S. Fomalik and John E. Frenett, entitled ANTIMICROBIAL AGENT TO INHIBIT THE GROWTH OF MICROORGANISM ON DISPOSABLE PRODUCTS (docket 91,789).

U.S. Ser. No. ______ filed concurrently herewith by David L. Patton, John R. Fredlund, Syamal K. Ghosh, Joseph A. Manico, Mark S. Fomalik, Lori L. Raybum-Zammiello, Brian P. Aylward, and John E. Frenett, entitled ANTIMICROBIAL AGENT TO INHIBIT THE GROWTH OF MICROORGANISM ON CLOTHING (docket 91,986).

U.S. Ser. No. ______ filed concurrently herewith by Joseph A. Manico, David L. Patton, John R. Fredlund, Syamal K. Ghosh, Lori L. Raybum-Zammiello, Mark S. Fomalik, Brian P. Aylward, and John E. Frenett, entitled ANTIMICROBIAL AGENT TO INHIBIT THE GROWTH OF MICROORGANISM ON BUILDING MATERIALS (docket 91,988).

### FIELD OF THE INVENTION

The present invention relates to an article made from fibers wherein an anti-microbial agent is incorporated to inhibit growth of microorganisms. More particularly, a fiber with an antimicrobial composition of specific silver salts and polymeric binders attached. The composition can be used to provide antimicrobial activity to the article for inhibiting the growth of microorganisms in solutions as well as on the surface of the fiber. More particularly, the fibers are used to make outerwear articles for personnel in the medical field.

### BACKGROUND OF THE INVENTION

In recent years people have become very concerned about exposure to the hazards of microbe contamination. For example, exposure to certain strains of Escherichia coli through the ingestion of under-cooked beef can have fatal consequences. Exposure to Salmonella enteritidis through contact with unwashed poultry can cause severe nausea. Mold (Aspergillis niger) and yeast (Candida albicans) may cause respiratory problems and skin infections. There is, in addition, increasing concern over pathogens, such as Salmonella and E. coli: O: 157, present in medical environments and concern over viruses such as Influenza, SARS, AIDS, and hepatitis. Indeed, some forms of bacteria, including Staphylococcus aureus are resistant to all but a few or one known antibiotic.

Noble metal-ions such as silver and gold ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella. In common practice, noble metals, metal-ions, metal salts or compounds containing metal-ions having antimicrobial properties, and other antimicrobial materials such as chlorophenyl compounds (Triclosan™), isothiazolone (Kathon™), antibiotics, and some polymeric materials, can be applied to surfaces to impart an antimicrobial property to the surface. If, or when, the surface is inoculated with harmful microbes, the antimicrobial metal-ions or metal complexes, if present in effective forms and concentrations, will slow or even prevent altogether the growth of those microbes.

In order for an antimicrobial article to be effective against harmful microorganisms, the antimicrobial compound must come in direct contact with microorganisms present in the surrounding environment, such as food, liquid nutrient or biological or non-biological fluid. Since physiological fluids are often extraordinarily complex, the treatment of a multitude of microbial contaminants may be difficult, if not impossible, with one antimicrobial compound. Further, the antimicrobial ions or compounds may be precipitated or complexed by components of the biological or physiological fluids and rendered ineffective. Microorganisms can develop resistance to organic compounds such as triclosan. Still further, microorganisms such as bacteria may develop resistance to antibiotics, biocides and antimicrobials, and more dangerous microbes may result.

The antimicrobial properties of silver have been known for several thousand years. The general pharmacological properties of silver are summarized in “Heavy Metals”—by Stewart C. Harvey and “Antiseptics and Disinfectants: Fungicides; Ectoparasiticides”—by Stewart Harvey in The Pharmacolopical Basis of Therapeutics, Fifth Edition, by Louis S. Goodman and Alfred Gilman (editors), published by MacMillan Publishing Company, NY, 1975. It is now understood that the affinity of silver ion to biologically important moieties such as sulfhlydryl, amino, imidazole, carboxyl and phosphate groups are primarily responsible for its antimicrobial activity.

The attachment of silver ions to one of these reactive groups on a protein results in the precipitation and denaturation of the protein. The extent of the reaction is related to the concentration of silver ions. The diffusion of silver ion into mammalian tissues is self-regulated by its intrinsic preference for binding to proteins through the various biologically important moieties on the proteins, as well as precipitation by the chloride ions in the environment. Thus, the very affinity of silver ion to a large number of biologically important chemical moieties (an affinity which is responsible for its action as a germicidal/biocidal/viricidal/fungicidal/bacteriocidal agent) is also responsible for limiting its systemic action—silver is not easily absorbed by the body. This is a primary reason for the tremendous interest in the use of silver containing species as an antimicrobial i.e. an agent capable of destroying or inhibiting the growth of microorganisms, including bacteria, yeast, fungi and algae, as well as viruses.

In addition to the affinity of silver ions to biologically relevant species, which leads to the denaturation and precipitation of proteins, some silver compounds, those having low ionization or dissolution ability, also function effectively as antiseptics. Distilled water in contact with metallic silver becomes antibacterial even though the dissolved concentration of silver ions is less than 100 ppb. There are numerous mechanistic pathways by which this oligodynamic effect is manifested i.e. by which silver ion interferes with the basic metabolic activities of bacteria at the cellular level, thus leading to a bactericidal and/or bacteriostatic effect.

A detailed review of the oligodynamic effect of silver can be found in “Oligodynamic Metals” by I. B. Romans in Disinfection Sterilization and Preservation, C. A. Lawrence and S. S. Bloek (editors), published by Lea and Fibiger (1968) and “The Oligodynamic Effect of Silver” by A. Goetz, R. L. Tracy and F. S. Harris, Jr. in Silver in Industry, Lawrence Addicks (editor), published by Reinhold Publishing Corporation, 1940. These reviews describe results that demonstrate that silver is effective as an antimicrobial agent towards a wide range of bacteria, and that silver can impact a cell through multiple biochemical pathways, making it difficult for a cell to develop resistance to silver. However, it is also known that the efficacy of silver as an antimicrobial agent depends critically on the chemical and physical identity of the silver source. The silver source may be silver in the form of metal particles of varying sizes, silver as a sparingly soluble material such as silver chloride, silver as a highly soluble salt such as silver nitrate, etc. The efficiency of the silver also depends on i) the molecular identity of the active species—whether it is Ag⁺ ion or a complex species such as (AgCl₂)⁻, etc., and ii) the mechanism by which the active silver species interacts with the organism, which depends on the type of organism. Mechanisms may include, for example, adsorption to the cell wall which causes tearing; plasmolysis where the silver species penetrates the plasma membrane and binds to it; adsorption followed by the coagulation of the protoplasm; or precipitation of the protoplasmic albumin of the bacterial cell. The antibacterial efficacy of silver is determined, among other factors, by the nature and concentration of the active species; the type of bacteria; the surface area of the bacteria that is available to interaction with the active species; the bacterial concentration; the concentration and/or the surface area of species that could consume the active species and lower its activity; and the mechanisms of deactivation.

It is clear from the literature on the use of silver based materials as antibacterial agents that there is no general procedure for precipitating silver based materials and/or creating formulations of silver based materials that would be suitable for all applications. Since the efficacy of the formulations depends on so many factors, there is a need for i) a systematic process for generating the source of the desired silver species, ii) a systematic process for creating formulations of silver based materials with a defined concentration of the active species; and iii) a systematic process for delivering these formulations for achieving predetermined efficacy. It is particularly a need for processes, which are simple and cost effective.

One very important use of silver based antimicrobials is for textiles. Various methods are known in the art to render antimicrobial properties to a target fiber. The approach of embedding inorganic antimicrobial agents, such as zeolites, into low melting components of a conjugated fiber is described in U.S. Pat. Nos. 4,525,410, and 5,064,599. In another approach, the antimicrobial agent may be delivered during the process of making a synthetic fiber such as those described in U.S. Pat. Nos. 5,180,402, 5,880,044, and 5,888,526, or via a melt extrusion process as described in U.S. Pat. Nos. 6,479,144, and 6,585,843. In still yet another process an antimicrobial metal ion may be ion exchanged with an ion exchange fiber as described in U.S. Pat. No. 5,496,860.

Methods of transferring an antimicrobial agent, in the form of an inorganic metal salt or zeolite, from one substrate to a fabric are disclosed in U.S. Pat. No. 6,461,386. High-pressure laminates containing antimicrobial inorganic metal compounds are disclosed in U.S. Pat. No. 6,248,342. Deposition of antimicrobial metals or metal-containing compounds onto a resin film or target fiber has also been described in U.S. Pat. Nos. 6,274,519, and 6,436,420.

It is also known in the art that fibers may be rendered with antimicrobial properties by applying a coating of silver particles. Silver ion-exchange compounds, silver zeolites and silver glasses are all known to be applied to fibers through topical applications for the purpose of providing antimicrobial properties to the fiber as described in U.S. Pat. Nos. 6,499,320, 6,584,668, 6,640,371 and 6,641,829. Other inorganic antimicrobial agents may be contained in a coating that is applied to a fiber as described in U.S. Pat. Nos. 5,709,870, 6,296,863, 6,585,767 and 6,602,811.

It is known in the art to use binders to apply coating compositions to impart antimicrobial properties to various substrates. U.S. Pat. No. 6,716,895 describes the use of hydrophilic and hydrophobic polymers and a mixture of oligodynamic metal salts as an antimicrobial composition, wherein the water content in the coating composition is preferably less than 50%. The mixture of oligodynamic metal salts are intended to span a wide range of solubilities and would not be useful in a durable coating application. U.S. Pat. No. 5,709,870 describes the use of carboxymethyl cellulose-silver complexes to provide an antimicrobial coating to a fiber. The use of silver halides in an antimicrobial coating, particularly for medical devices, is described in U.S. Pat. No. 5,848,995.

In particular, the prior art has disclosed formulations that are useful for highly soluble silver salts having solubility products, herein referred to as pKsp, of less than 1. Generally, these silver salts require the use of hydrophobic addenda to provide the desired combinations of antimicrobial behavior and durability. Conversely, it is also know that very insoluble metallic silver particles, having a pKsp greater than 15 would require hydrophilic addenda to provide the desired combinations of antimicrobial behavior and durability.

It is well known in the photographic art that gelatin is a useful hydrophilic polymer in the production of photographic silver halide emulsions. Gelatin is present during the precipitation of, for example, silver chloride from its precursor salts. For most practical photographic coating formulations the amount of gelatin is above 3% during the precipitation stages and preferably above 10% during the coating applications for film or paper products. It is a desirable feature that the gelatin is present in an amount sufficient to solidify or gel the composition. This is desired to minimize settling of the dense silver halide particles. The high gelatin levels are themselves a source of bioactivity and it is common practice to add biostats or biocides to minimize or prevent spoilage of the photographic emulsion prior to the coating application.

Although the approaches in the prior art for rendering antimicrobial properties to a fiber through the use of an inorganic metal compounds may be viable, there remains the need to deliver a cost effective source of inorganic metal compounds that is easy to apply to the target fiber and which is durable and efficient in it's antimicrobial behavior.

### SUMMARY OF THE INVENTION

In general terms, the present invention provides an article made from fibers wherein the fibers are treated with anti-microbial agents including silver halide particles in order to inhibit growth of microorganisms.

In one embodiment, an article having an antimicrobial agent to inhibit the growth of microorganisms in biological, non-biological and physiological fluids is provided. The article includes a structure having fibers and silver halide particles bound to the fibers using a hybrophilic gelatin polymer composition that does not substantially solidity or gel.

In another embodiment, a method for creating an article having an antimicrobial agent to inhibit the growth of microorganisms in biological, non-biological and physiological fluids is provided. The method includes providing a structure having fibers and binding silver halide particles to the fibers using a hydrophilic gelatin polymer composition that does not substantially solidity or gel. In yet another embodiment, a method for creating an article having an antimicrobial agent to inhibit the growth of microorganisms in biological, non-biological and physiological fluids is provided. The method includes providing a structure having fibers, binding silver halide particles to the fibers using a hydrophilic gelatin polymer composition which does not substantially solidify or gel, and applying a hydrophobic binder resin to the fibers.

### BRIEF DESCRIPTION OF THE DRAWINGS

FIG. 1 is a photograph showing untreated fibers;

FIGS. 2A and 2B are photographs showing fibers treated with silver halide particles in accordance with the present invention;

FIG. 3 illustrates a plan view of a hospital garment made in accordance with the present invention; and

FIG. 4 is an enlarged partial cross sectional view of a portion of the garment of FIG. 3 as taken along line 4-4.

### DETAILED DESCRIPTION OF THE INVENTION

Various embodiments will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

This invention can be applied to textiles to provide antibacterial and/or anti-fungal protection to the textile in a variety of end-use applications. Topical application of this material is accomplished through traditional padding technology (dip coating), followed by a short, high-temperature curing step to permanently link the antimicrobial material to the textile. Typical end-use applications include articles used by a person as an outerwear during medical care for patients.

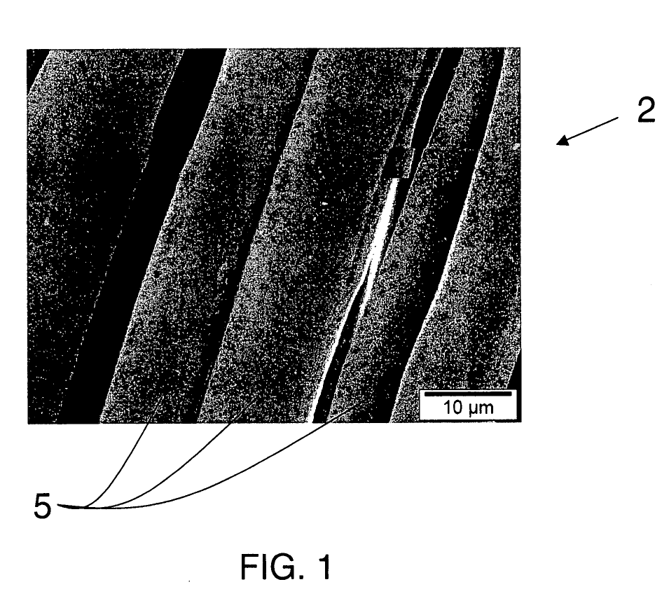

FIG. 1 is a photograph illustrating typical fibers that have not been treated with antimicrobial agents, generally shown as 2. In one embodiment of FIG. 1, numerous fibers 5 can form an article. The fibers 5 have not been treated with an antimicrobial agent, such as silver halide particles.

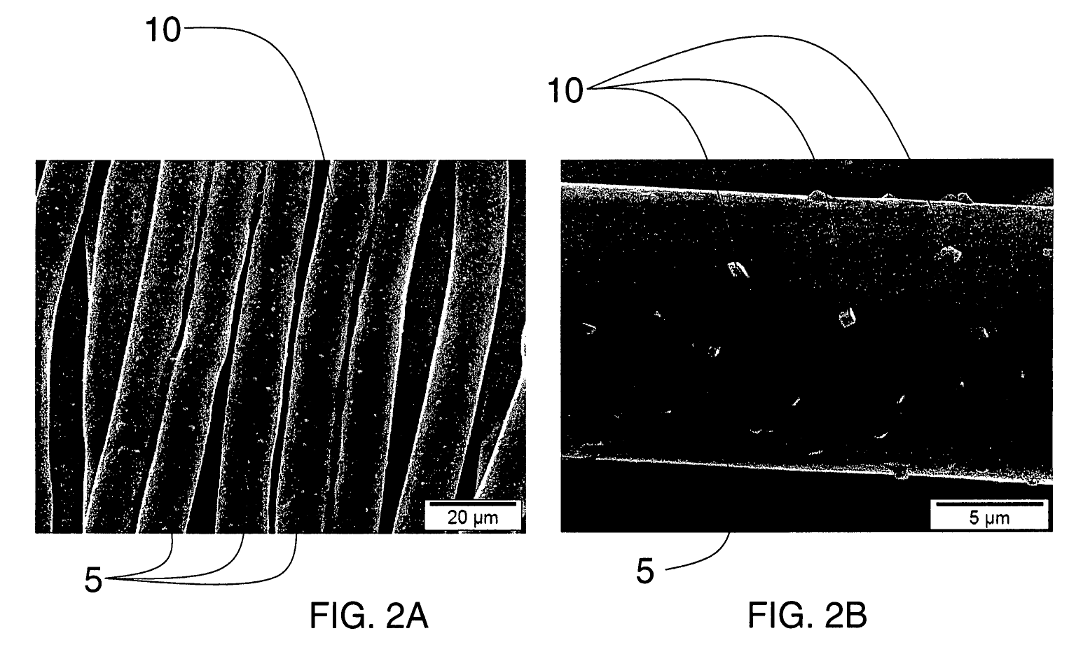

FIG. 2A is a photograph showing fibers 5 which have been treated using a process that applies silver halide particles 10 and a hydrophilic polymer (not shown) in accordance with one embodiment. Similarly, FIG. 2B is a photograph showing a single fiber 5 with the silver halide particles 10 attached.

The term inhibition of microbial-growth, or a material which “inhibits” microbial growth, is used by the authors to mean materials that prevent microbial growth, subsequently kills microbes so that the population is within acceptable limits, significantly retard the growth processes of microbes or maintain the level or microbes to a prescribed level or range. The prescribed level can vary widely depending upon the microbe and its pathogenicity; generally it is preferred that harmful organisms are present at no more than 10 organisms/ml and preferably less than 1 organism/ml.

Antimicrobial agents which kill microbes or substantially reduce the population of microbes are often referred to as biocidal agents, while materials which simply slow or retard normal biological growth are referred to as biostatic agents. The preferred impact upon the microbial population can vary widely depending upon the application. For example, in pathogenic organisms (such as Group A streptococcal) a biocidal effect is preferred, while for less harmful organisms a biostatic impact is preferred. Generally, it is preferred that microbiological organisms remain at a level, which is not harmful to the consumer or user of that particular article, or to the function of the treated article.

In one embodiment, an antimicrobial agent composition includes at least 50% water, silver halide particles 10, and a hydrophilic polymer, i.e., hydrophilic binder. The hydrophilic polymer is of a type and used in an amount wherein the composition does not substantially gel or solidify at 25 degrees C. In practical terms the composition, when sold as a concentrate, must be able to flow at 25 degrees C. and be easily mixed with an aqueous diluent or other addenda prior to use as an antimicrobial coating for yam or textile. The composition also encompasses a more diluted form that is suitable for dip, pad, or other types of coating.

The composition is substantially free of organic solvents. Preferably, no organic solvent is intentionally added to the composition. The composition must exhibit antimicrobial activity upon drying. In its concentrated form the composition must comprise at least 50% water by weight. In one embodiment it comprises at least 70% water by weight. In its diluted form the composition can be greater than 95% water.

The silver halide particles 10 can be of any shape and halide composition. The type of halide can include chloride, bromide, iodide and mixtures of them. The silver halide particles 10 can be, for example, silver bromide, silver iodobromide, bromoiodide, silver iodide or silver chloride. However, the invention is not limited to these compositions, and any suitable composition can be used. In one embodiment the silver halide particles 10 are predominantly silver chloride. The predominantly silver chloride particles can be, for example, silver chloride, silver bromochloride, silver iodochloride, silver bromoiodochloride and silver iodobromochloride particles. By predominantly silver chloride, it is meant that the particles are greater than about 50 mole percent silver chloride. Preferably, they are greater than about 90 mole percent silver chloride; and optimally greater than about 95 mole percent silver chloride. The silver halide particles 10 can either be homogeneous in composition or the core region can have a different composition than the shell region of the particles. The shape of the silver halide particles can be cubic, octahedral, tabular or irregular. More silver halide properties can be found in “The Theory of the Photographic Process”, T. H. James, ed., 4th Edition, Macmillan (1977). In one embodiment the silver halide particles have a mean equivalent circular diameter of less than 1 micron, and preferably less 0.5 microns.

The silver halide particles 10 and associated coating composition of the present invention are applied to the fiber 5 or fabric in an amount sufficient to provide antimicrobial properties to the treated fiber for a minimum of at least 10 washes, more preferably 20 washes and most preferably after 30 washes in accordance with ISO 6330:2003. The amount of silver halide particles 10 applied to the target fiber 5 or textile fabric is determined by the desired durability or length of time of antimicrobial properties. The amount of silver halide particles 10 present in the composition will depend on whether the composition is one being sold in a concentrated form suitable for dilution prior to coating or whether the composition has already been diluted for coating.

Typical levels of silver salt particles (by weight percent) in the formulation are preferably from about 0.000001% to about 10%, more preferably from about 0.0001% to about 1% and most preferably from about 0.001% to 0.5%. In a concentrated format, the composition preferably includes silver halide particles in an amount of 0.001 to 10%, more preferably 0.001 to 1%, and most preferably 0.001 to 0.5%. In a diluted format, the composition preferably includes silver halide particles in an amount from about 0.000001% to about 0.01%, more preferably from about 0.00001% to about 0.01% and most preferably from about 0.0001% to 0.01%. It is a desirable feature of the embodiment to provide efficient antimicrobial properties to the target fiber or textile fabric at a minimum silver halide level to minimize the cost associated with the antimicrobial treatment.

In one embodiment, the preferred hydrophilic polymers are soluble in water at concentrations greater than approximately 2%, preferably greater than approximately 5%, and more preferably greater than approximately 10%. Therefore, suitable hydrophilic polymers do not require an organic solvent to remain fluid at 25 degrees C. Suitable hydrophilic polymers useful in the embodiment include, for example, gelatin, polyacrylic acid, polyacrylamide, polyvinyl alcohol, polyvinylpyrrolidones, cellulose etc. into the reaction vessel The polymers peptize or stabilize silver halide particles help maintain colloidal stability of the solution.

In another embodiment, a preferred hydrophilic polymer is gelatin. Gelatin is an amphoteric polyelectrolyte that has excellent affinity to a number of substrates. The gelatin can be processed by any of the well-known techniques in the art including, but not limited to: alkali- treatment, acid-treatment, acetylated gelatin, phthalated gelatin or enzyme digestion. The gelatin can have a wide range of molecular weights and can include low molecular weight gelatins if it is desirable to raise the concentration of the gelatin in the inventive composition without solidifying the composition. The gelatin in the present embodiment is added in an amount sufficient to peptize the surface of the silver halide and some excess of gelatin will always be present in the water phase. The gelatin level can be chosen such that the composition does not substantially solidify or gel. In the present embodiment, the weight percentage of gelatin is less than 3%, preferably less than 2%, and more preferably less than 1%. The gelatin of the present embodiment can also be cross-linked in order to improve the durability of the coating composition containing the antimicrobial silver halide particles 10.

Silver halide particles can be formed by reacting silver nitrate with halide in aqueous solution. In the process of silver halide precipitation, one can add the hydrophilic polymers to peptize the surface of the silver halide particles thereby imparting colloidal stability to the particles, see for example, Research Disclosure September 1997, Number 401 published by Kenneth Mason Publications, Ltd., Dudley Annex, 12a North Street, Emsworth, Hampshire PO10 7DQ, ENGLAND, the contents of which are incorporated herein by reference.

In addition to the hydrophilic binder, a hydrophobic binder resin is preferably used to improve the adhesion and durability of the silver salt particles once applied to a fabric surface. Such hydrophobic binders are well known in the art and are typically provided as aqueous suspensions of polymer microparticles. Materials suitable for use as hydrophobic binders include, but are not limited to, acrylic, styrene-butadiene, polyurethane, polyester, polyvinyl acetate, polyvinyl acetal, vinyl chloride and vinylidine chloride polymers, including copolymers thereof. In one embodiment, acrylic polymers and polyurethane are preferred.

The hydrophobic binders should have film-forming properties that include a range of glass transition temperatures from about −30 C. to about 90 C. The hydrophobic binder particles can have a wide range of particle sizes from about 10 nm to about 10,000 nm and can be polydisperse in distribution. The hydrophobic binders can also be thermally or chemically crosslink able in order to modify the desired durability properties of the antimicrobial fiber or fabric textile. The hydrophobic binders can be nonionic or anionic in nature. Useful ranges of the hydrophobic binders are generally less than about 10% of the composition. It is understood that the choice of the hydrophobic binder can be related to specific end use requirements of the fiber or fabric textile including, wash resistance, abrasion (crock), tear resistance, light resistance, coloration, hand and the like. As described in more detail below the hydrophobic binder is generally kept separate from the hydrophilic polymer/silver halide particle composition until a short time prior to coating.

In one embodiment, a composition including silver salt particles, hydrophilic binder and optionally, hydrophobic binder or gelatin cross-linker, can be applied to the target fiber or textile fabric in any of the well know techniques in art. These techniques include, but are not limited to, pad coating, knife coating, screen coating, spraying, foaming and kiss-coating. The components of the composition are preferably delivered as a separately packaged two-part system involving colloidal silver halide particles and hydrophilic binder as one part (part A) and a second part (part B) including an aqueous suspension of a hydrophobic binder, or gelatin cross-linker, and optionally, a second hydrophilic binder that can be the same or different as the hydrophilic binder from part A. The first part, including colloidal silver halide particles and hydrophilic binder, has an excellent shelf-life without compromising colloidal stability. The two parts can be combined prior to a padding or coating operation and exhibit colloidal stability for the useful shelf-life of the composition, typically on the order of several days.

There can also be present optional components, for example, thickeners or wetting agents to aid in the application of the composition to the target fiber or textile fabric. Examples of wetting materials include surface active agents commonly used in the art such as ethyleneoxide-propyleneoxide block copolymers, polyoxyethylene alkyl phenols, polyoxyethylene alkyl ethers, and the like. Compounds useful as thickeners include, for example, particulates such as silica gels and smectite clays, polysaccharides such as xanthan gum, polymeric materials such as acrylic-acrylic acid copolymers, hydrophobically modified ethoxylated urethanes, hydrophobically modified nonionic polyols, hydroxypropyl methylcellulose and the like.

Also, an agent to prevent latent image formation is useful in the compositions. Some silver salts are light sensitive and discolor upon irradiation of light. However, the degree of light sensitivity can be minimized by several techniques known to those who are skilled in the art. For example, storage of the silver halide particles in a low pH environment will minimize discoloration. In general, pH below 7.0 is desired and more specifically, pH below 4.5 is preferred. Another technique to inhibit discoloration involves adding compounds of elements, such as, iron, iridium, rhuthinium, palladium, osmium, gallium, cobalt, rhodium, and the like, to the silver halide particles. These compounds are known in the photographic art to change the propensity of latent image formation; and thus the discoloration of the silver salt. Additional emulsion dopants are described in Research Disclosure, February 1995, Volume 370, Item 37038, Section XV.B., published by Kenneth Mason Publications, Ltd., Dudley Annex, 12a North Street, Elmsworth, Hampshire PO10 7DQ, England.

The embodiment is not limited to any particular fiber or textile fabric or yam including, exhaustively any natural or manufactured fibers. Examples of natural fibers include, but are not limited to, cotton (cellulosic), wool, or other natural hair fibers, for example, mohair and angora. Examples of manufactured fibers include synthetics, such as, polyester, polypropylene, nylon, acrylic, polyamide, or, regenerated materials such as cellulosics and the like, or blends of materials such as polyester/cotton. The target fiber or yarn can include any number of chemistries or applications prior to, during and/or after the application of the antimicrobial composition including, for example, antistatic control agents, flame retardants, soil resistant agents, wrinkle resistant agents, shrink resistant agents, dyes and colorants, brightening agents, UV stabilizers, lubricants, antimigrants, and the like.

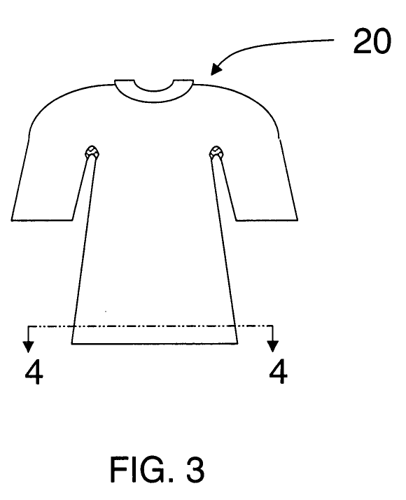

FIG. 3 illustrates a garment that can be used in a laboratory environment made in accordance with the present embodiment. The laboratory environment can include, but is not limited to, a medical, surgical, clinical, biological, testing and research environment. A hospital garment 20, for example, can be a medical uniform, covering, scrub, facemask, shield or the like.

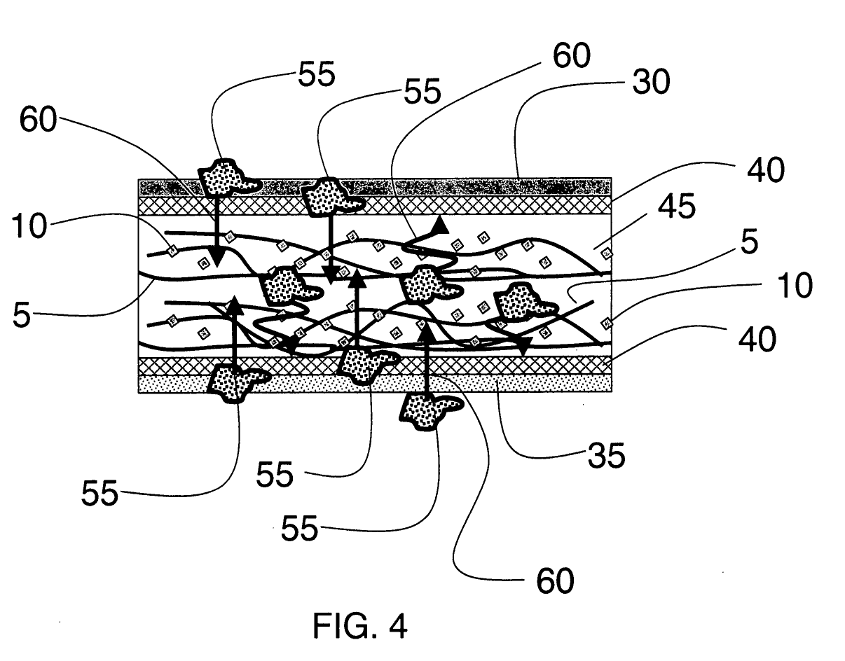

FIG. 4 illustrates an enlarged cross-sectional view of the medical garment 20 (e.g., hospital garment) shown in FIG. 3. The hospital garment 20 includes an outer covering 30, a body-side liner 35, a barrier layer 40 and an absorbent core 45 located between liquid permeable barrier layers 40. The absorbent core 45 can include any fibrous absorbent structures. The fibers 5 that are treated with silver halide particles 10 are located in the absorbent core 45. As fluids contact the outer layer 30, they are absorbed and transferred through the water permeable polymer of the barrier layer 40.

The water permeable polymer permits fluids to move freely through the barrier layer 40 and into the absorbent core 45 allowing the microorganisms 55 to come into close proximity to the silver halide particles 10. By using the sliver halide particles 10 to significantly reduce the amount of microorganisms 55 in the bodily fluids captured by the hospital garment 20, the growth of the microorganism 55 is eliminated or substantially reduced, preventing infection and eliminating odor. In order for the silver halide particles 10 to work properly, the outer covering 30, the body-side liner 35, the barrier layer 40, and absorbent core 45 containing the fibers 5 with the silver halide particles 10, must be permeable to water as previously described, with the barrier permitting the microorganism 55 to travel only in the direction indicated by the arrow 60. Once the microorganism 55 enters the absorbent core 45, the microorganism 55 is prohibited by the barrier layer 40 from escaping the absorbent core 45.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

### PARTS LIST

2 untreated fibers
5 fibers
10 silver halide particles
20 garment
30 outer covering
35 body-side liner
40 barrier layer
45 absorbent core
55 microorganisms
60 arrow

What is claimed is:

1. An article having an antimicrobial agent to inhibit the growth of microorganisms in biological, non-biological and physiological fluids, the article comprising:
a structure having fibers; and
silver halide particles bound to the fibers using a hydrophilic gelatin polymer composition that does not substantially solidify or gel.

2. The article of claim 1, wherein the weight percentage of the gelatin in the composition is in the range of 1 to 3%.

3. The article of claim 1 further comprising a hydrophobic binder resin applied to the fibers to improve adhesion and durability of the silver halide particles.

4. The article of claim 3, wherein the hydrophobic binder has film-forming properties with a glass transition temperature ranging from about−30 C. to about 90 C.

5. The article of claim 3, wherein the hydrophobic binder has poly-dispersed particles with sizes ranging from about 10 nm to about 10,000 nm.

6. The article of claim 3, wherein the hydrophobic binder comprises one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

7. The article of claim 1, wherein the silver halide particles further comprises silver halide particles of any shape and halide composition.

8. The article of claim 1, wherein the silver halide particles are selected from the group consisting of chloride, bromide and iodide.

9. The article of claim 8, wherein the group further comprises combinations of chloride, bromide, and iodide.

10. The article of claim 1 further comprising a barrier layer that is permeable to water.

11. The article of claim 10, wherein the barrier layer has a thickness in the range of 0.1 microns to 10.0 microns.

12. The article of claim 10, wherein the barrier layer comprises one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate , polyamide, polymethacrylate, polyethylene terephthalate, polystyrene, polyethylene and polypropylene or polyacrylonitrile.

13. The article of claim 1, where the structure is designed to be placed in contact with a body of a human and an animal.

14. The article of claim 1, where the structure is designed to be placed within a body of a human and animal.

15. The article of claim 1, where the structure is designed to be in close proximity of a body of a human and an animal.

16. The article of claim 1, wherein the structure comprises one from the group consisting of a medical uniform, covering, scrub, facemask, and shield.

17. The article of claim 16 further comprising a liquid permeable barrier layer for allowing the biological or physiological fluids to come in contact with the silver halide particles.

18. The article of claim 1, wherein the silver halide particles maintain microorganisms in a substantially biostatic state.

19. The article of claim 1, wherein the silver halide particles maintain microorganisms in a substantially biocidal state.

20. The article of claim 1, wherein the silver halide particles maintain microorganisms to a prescribed level.

21. The article of claim 1, wherein the silver halide particles maintain microorganisms to a level that will not harm users.

22. The article of claim 1, wherein the structure is treated to prevent discoloration.

23. A method for creating an article having an antimicrobial agent to inhibit the growth of microorganisms in biological, non-biological and physiological fluids, the method comprising:
providing a structure having fibers; and
binding silver halide particles to the fibers using a hydrophilic gelatin polymer composition that does not substantially solidify or gel.

24. The method of claim 23, wherein using the hydrophilic gelatin polymer composition further comprises using a hydrophilic gelatin polymer composition having a weight percentage of the gelatin in the range of 1 to 3%.

25. The method of claim 23 further comprising applying a hydrophobic binder resin to the fibers.

26. The method of claim 25, wherein applying the hydrophobic binder further comprises applying a hydrophobic binder having film-forming properties with a glass transition temperature ranging from about −30 C. to about 90 C.

27. The method of claim 25, wherein applying the hydrophobic binder further comprises applying a hydrophobic binder having poly-dispersed particles with sizes ranging from about 10 nm to about 10,000 nm.

28. The method of claim 23 further comprising selecting the silver halide particles from the group consisting of chloride, bromide and iodide.

29. The method of claim 28, wherein the group further comprises selecting combinations of chloride, bromide, and iodide.

30. The method of claim 23 further comprising providing a polymer or polymeric layer containing fibers coated with the silver halide particles.

31. The method of claim 30, wherein providing the polymer further comprises providing a polymer that is permeable to water.

32. The method of claim 31, wherein providing the polymer further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

33. The method of claim 23 further comprising providing a barrier layer that is permeable to water.

34. The method of claim 33, wherein providing the barrier layer further comprises providing a barrier layer having a thickness in the range of 0.1 microns to 10.0 microns.

35. The method of claim 33, wherein providing the barrier layer further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate , polyamide, polymethacrylate, polyethylene terephthalate, polystyrene, polyethylene and polypropylene or polyacrylonitrile.

36. The method of claim 23 further comprising placing the structure in contact with a body of a human and an animal.

37. The method of claim 23 further comprising placing the structure within a body of a human and an animal.

38. The method of claim 23 further comprising placing the structure in close proximity of a body of a human and an animal.

39. The method of claim 23 further comprising maintaining the microorganisms in a substantially biostatic state.

40. The method of claim 23 further comprising maintaining the microorganisms in a substantially biocidal state.

41. The method of claim 23 further comprising maintaining the microorganisms to a prescribed level.

42. The method of claim 23 further comprising maintaining the microorganisms to a level that will not harm users.

43. The method of claim 23 further comprising replacing the structure after a predetermined time period.

44. The method of claim 23, wherein the structure comprises one from the group consisting of a medical uniform, covering, scrub, facemask, and shield.

45. A method for creating an article having an antimicrobial agent to inhibit the growth of microorganisms in biological, non-biological and physiological fluids, the method comprising:
providing a structure having fibers;
binding silver halide particles to the fibers using a hydrophilic gelatin polymer composition which does not substantially solidify or gel; and
applying a hydrophobic binder resin to the fibers.

46. The method of claim 45, wherein using the hydrophilic gelatin polymer composition further comprises using a hydrophilic gelatin polymer composition having a weight percentage of the gelatin in the range of 1 to 3%.

47. The method of claim 45, wherein applying the hydrophobic binder further comprises applying a hydrophobic binder having film-forming properties with a glass transition temperature ranging from about −30 C. to about 90 C.

48. The method of claim 45, wherein applying the hydrophobic binder further comprises applying a hydrophobic binder having poly-dispersed particles with sizes ranging from about 10 nm to about 10,000 nm.

49. The method of claim 45 further comprising selecting the silver halide particles from the group consisting of chloride, bromide and iodide.

50. The method of claim 49, wherein the group further comprises selecting combinations of chloride, bromide, and iodide

51. The method of claim 45 further comprising providing a polymer or polymeric layer containing fibers coated with the silver halide particles.

52. The method of claim 51, wherein providing the polymer further comprises providing a polymer that is permeable to water.

53. The method of claim 52, wherein providing the polymer further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

54. The method of claim 45 further comprising providing a barrier layer that is permeable to water.

55. The method of claim 54, wherein providing the barrier layer further comprises providing a barrier layer having a thickness in the range of 0.1 microns to 10.0 microns.

56. The method of claim 54, wherein providing the barrier layer further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate , polyamide, polymethacrylate, polyethylene terephthalate, polystyrene, polyethylene and polypropylene or polyacrylonitrile.

57. The method of claim 45 further comprising placing the structure in contact with a body of a human and an animal.

58. The method of claim 45 further comprising placing the structure within a body of a human and an animal.

59. The method of claim 45 further comprising placing the structure in close proximity of a body of a human and an animal.

60. The method of claim 45 further comprising maintaining microorganisms in a substantially biostatic state.

61. The method of claim 45 further comprising maintaining microorganisms in a substantially biocidal state.

62. The method of claim 45 further comprising maintaining he microorganisms to a prescribed level.

63. The method of claim 45 further comprising maintaining microorganisms to a level that will not harm users.

64. The method of claim 45 further comprising replacing the structure after a predetermined time period.

65. The method of claim 45, wherein the structure comprises one from the group consisting of a medical uniform, covering, scrub, facemask, and shield.
